(19) United States
(12) Patent Application Publication
(10) Pub. No.: US 2022/0121007 A1
(43) Pub. Date: Apr. 21, 2022

(54) LENS ASSEMBLY FOR ELECTRONIC DEVICE

(71) Applicant: HON HAI PRECISION INDUSTRY CO., LTD., New Taipei (TW)

(72) Inventors: YU-CHIAO HUANG, New Taipei (TW); CHUN-CHENG KO, New Taipei (TW)

(21) Appl. No.: 17/135,310

(22) Filed: Dec. 28, 2020

(30) Foreign Application Priority Data
Oct. 20, 2020 (CN) 202011126473.8

(51) Int. Cl. G02B 13/00; G02B 9/62

(52) U.S. Cl. CPC G02B 13/0045; G02B 9/62

(57) ABSTRACT

A lens assembly includes a first lens, a second lens, a third lens, a fourth lens, a fifth lens, and a sixth lens. The first lens, the second lens, the third lens, the fourth lens, the fifth lens, and the sixth lens are sequentially arranged from an object side to an image side. The lens assembly satisfies the following relationships:

|PV_{S1-S6}|≤0.3;

|PV_{S7}−PV_{S8}|≤|PV_{S11}−PV_{S12}|≤1;

|PV_{S1}/PV_{S12}|≤3;

PV is an error between an actual surface shape and a standard surface shape of the first lens, the second lens, the third lens, the fourth lens, the fifth lens, and the sixth lens. PV_{Sn} is an error of crests and troughs between an actual surface shape and a standard surface shape of the first surface to an nth surface, and n is a positive integer less than 13.

### FIELD

The subject matter herein generally relates to lens assemblies, and more particularly to a lens assembly for an electronic device.

### BACKGROUND

Injection-molded plastic lenses generally have the advantages of low manufacturing cost and rapid mass production and are widely used. The injection-molded plastic lens may have different mold processing or mold condition parameters, which may cause the actual surface shape of the molded lens to be different from the originally designed lens. Ideally, the face of the actual molded lens should be the same as the designed face. However, due to the limitation of processing and molding technology, it is not easy for the actual molded lens to be exactly the same as the designed face. The surface shape of the actual molded lens is likely to be different from the designed lens surface due to processing errors and unstable molding, which will affect the imaging quality of the lens assembly, reduce yield, and increase process costs.

### BRIEF DESCRIPTION OF THE DRAWINGS

Implementations of the present disclosure will now be described, by way of embodiments, with reference to the attached figures.

FIG. 1 is a cross-sectional diagram of a lens assembly.

FIG. 2 is a schematic diagram of a seventh surface and an eighth surface of a fourth lens shown in FIG. 1 as a u-n-type or n-u-type pair.

FIG. 3 is a schematic diagram of light rays entering the lens assembly.

FIG. 4 is a graph showing MTF imaging curves of lens assemblies according to a first and second embodiment and a standard design lens assembly.

FIG. 5 is a graph of MTF imaging curves of the lens assemblies according to a third and fourth embodiment and the standard design lens assembly.

FIG. 6 is a schematic diagram of an electronic device having the lens assembly.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series, and the like.

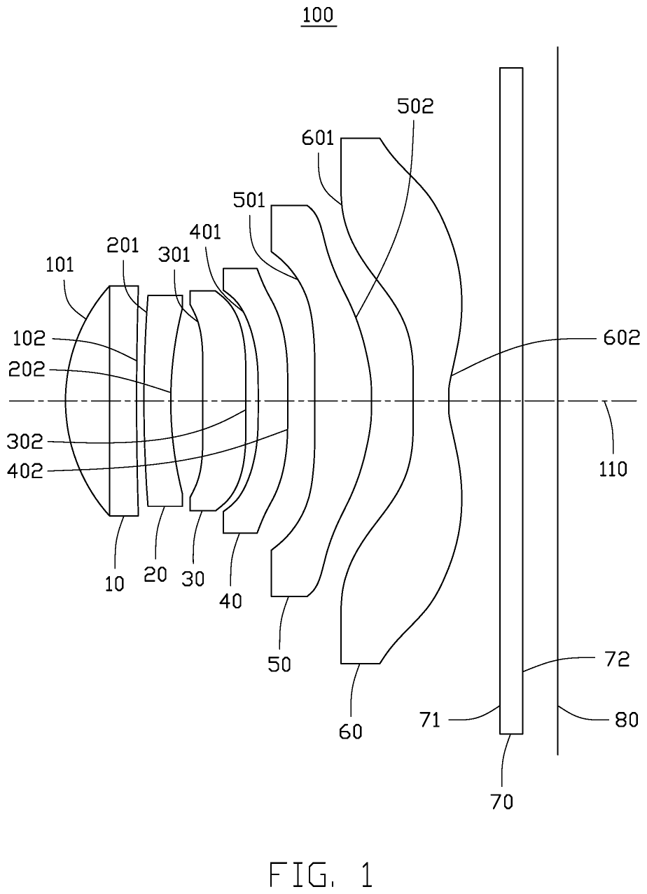

FIG. 1 shows an embodiment of a lens assembly 100. In one embodiment, the lens assembly 100 includes a first lens 10, a second lens 20, a third lens 30, a fourth lens 40, a fifth lens 50, a sixth lens 60, a filter 70, and an image surface 80 arranged in sequence from an object side to an image side.

The lens assembly 100 includes an optical axis 110. The first lens 10, the second lens 20, the third lens 30, the fourth lens 40, the fifth lens 50, and the sixth lens 60 are all symmetrically arranged about the optical axis 110.

The first lens 10 has a negative refractive power and includes a first surface 101 and a second surface 102. The first surface 101 protrudes toward the object side, and the second surface 102 is a flat surface.

The second lens 20 has a positive refractive power. The second lens 20 includes a third surface 201 and a fourth surface 202. The third surface 201 is a flat surface facing the second surface 102, and the fourth surface 202 is recessed toward the object side.

The third lens 30 has a positive refractive power. The third lens 30 includes a fifth surface 301 and a sixth surface 302. The fifth surface 301 is recessed toward the image side, and the sixth surface 302 protrudes toward the image side.

The fourth lens 40 has a positive refractive power. The fourth lens 40 includes a seventh surface 401 and an eighth surface 402. The seventh surface 401 faces the sixth surface 302. Two ends of the seventh surface 401 are flat surfaces, and a middle portion of the seventh surface 401 is recessed toward the image side. The eighth surface 402 protrudes toward the image side.

The fifth lens 50 has a negative refractive power. The fifth lens 50 includes a ninth surface 501 and a tenth surface 502. The ninth surface 501 faces the eighth surface 402. Two ends of the ninth surface 501 are flat surfaces, and a middle portion of the ninth surface 501 is recessed toward the image side. The tenth surface 502 protrudes toward the image side. A thickness of a middle portion of the fifth lens 50 is greater than a thickness of the two ends.

The sixth lens 60 has a positive refractive power. The sixth lens 60 includes an eleventh surface 601 and a twelfth surface 602. The eleventh surface 601 faces the tenth surface 502. Two ends of the eleventh surface 601 are flat, and a middle portion of the eleventh surface 601 is recessed toward the image side. Two ends of the twelfth surface 602 protrude toward the image side, and a middle portion of the twelfth surface is recessed toward the object side. A thickness of the middle portion of the sixth lens 60 is smaller than a thickness of the two ends.

The first lens 10, the second lens 20, the third lens 30, the fourth lens 40, the fifth lens 50, and the sixth lens 60 are aspherical lenses that satisfy the following formula:

$$Z = \frac{c {r}^{2}}{1 + \sqrt{1 - ( 1 + K ) {c}^{2} {r}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16} + {A}_{18} {h}^{18} + {A}_{20} {h}^{20} + {A}_{22} {h}^{22}$$

wherein:
z is a concavity of an aspheric surface;
c is a reciprocal of a radius of curvature;
r is an off-axis radius;
k is a conic coefficient;
A4, A6, A8, A10, A12, A14, A16, A18, A20, A22 are order coefficients of the aspheric surface.

The filter 70 is used to filter infrared light in a light passing through the sixth lens 60. The filter 70 includes a front surface 71 and a rear surface 72 opposite the front surface.

The image surface 80 is used for imaging.

The lens assembly 100 satisfies the following relationships:

|PV_{S1-S6}|≤0.3 (Formula 1);

|PV_{S7}−PV_{S8}|≤|PV_{S11}−PV_{S12}|≤1 (Formula 2);

|PV_{S1}/PV_{S12}|≤3 (Formula 3);

wherein:
PV is an error between an actual surface shape and a standard surface shape of the first lens 10, the second lens 20, the third lens 30, the fourth lens 40, the fifth lens 50, and the sixth lens 60;
PV_{Sn} is an error of crests and troughs between an actual surface shape and a standard surface shape of the first surface to an nth surface, and n is a positive integer less than 13.

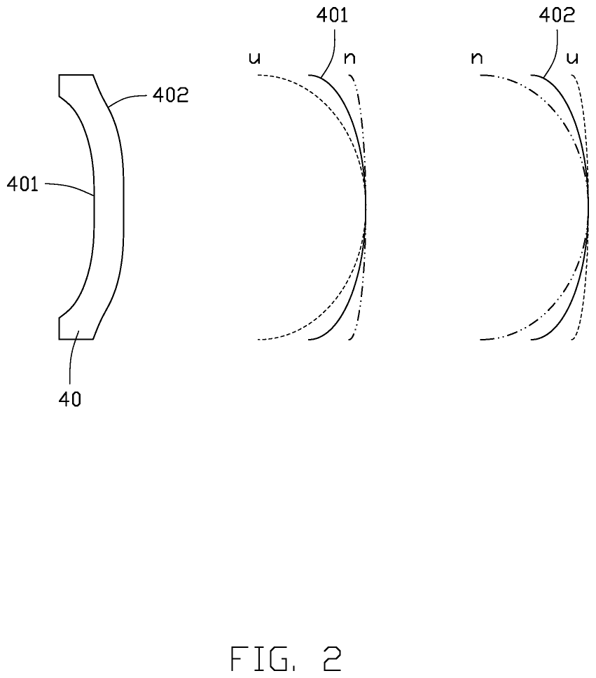

Referring to FIG. 2, taking the seventh surface 401 and the eighth surface 402 as an example, the first surface 101 and the second surface 102, the third surface 201 and the fourth surface 202, the fifth surface 301 and the sixth surface 302, the seventh surface 401 and the eighth surface 402, the ninth surface 501 and the tenth surface 502, and the eleventh surface 601 and the twelfth surface 602 are u-n-type or n-u-type pairs.

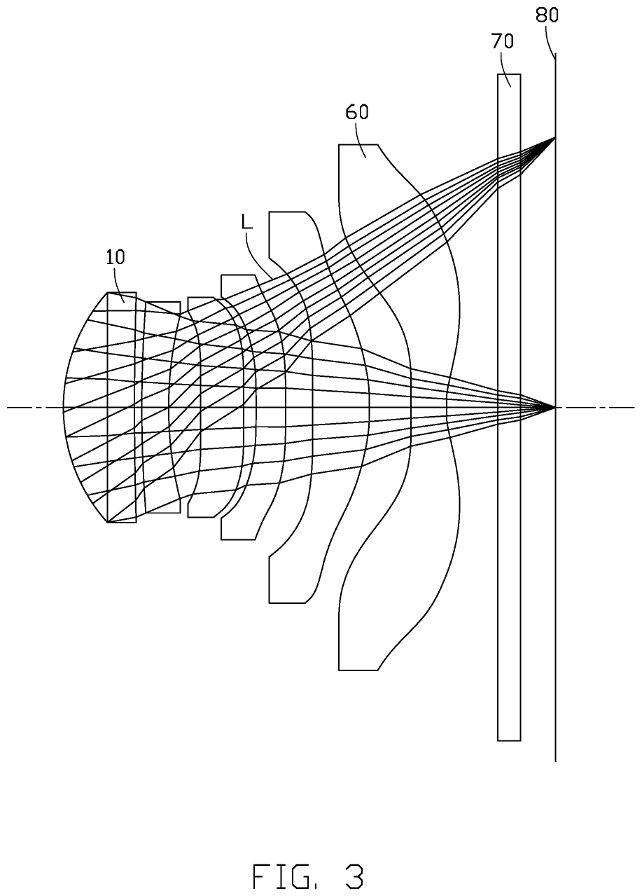

Referring to FIG. 3, light rays L for each field of view pass through nearly an entire surface of the lens closest to the object side (the first lens 10), and the light rays L for each field of view only pass through a portion of a surface of the lens closest to the image side (the sixth lens 60). The lens closest to the object side is sensitive to all fields of view, which will easily affect an overall imaging quality of the lens. Therefore, the PV value of the lens closest to the object side is controlled in a smaller range. The lens closest to the image side is sensitive to peripheral fields of view. Therefore, the PV value of the lens closest to the image side is controlled in a larger range.

The lens assembly 100 will be described in detail below in specific embodiments.

### Embodiment 1

PV_{S1}: 0.16 μm (u type), PV_{S2}: 0.16 μm (n type), PV_{S3}: 0.11 μm (u type), PV_{S4}: 0.26 μm (n type), PV_{S5}: 0.25 μm (u type), PV_{S6}: 0.13 μm (n type), PV_{S7}: 0.23 μm (u type), PV_{S8}: 0.19 μm (n type), PV_{S9}: 0.27 μm (u type), PV_{S10}: 0.15 μm (n type), PV_{S11}: 0.53 μm (u type) and PV_{S12}: 1.17 μm (n-type). Among them, |PV_{S1-S6}|<0.3, |PV_{S7}−PV_{S8}|=0.04, |PV_{S11}−PV_{S12}|=0.64, |PV_{S1}/PV_{S12}|≈0.14, which conform to the above formulas 1-3.

### Embodiment 2

PV_{S1}: 0.17 μm (u type), PV_{S2}: 0.19 μm (n type), PV_{S3}: 0.09 μm (u type), PV_{S4}: 0.23 μm (n type), PV_{S5}: 0.25 μm (u type), PV_{S6}: 0.27 μm (n type), PV_{S7}: 0.21 μm (u type), PV_{S8}: 0.21 nm (n type), PV_{S9}: 0.27 μm (u type), PV_{S10}: 0.15 μm (n type), PV_{S11}: 0.58 μm (u type) and PV_{S12}: 1.15 μm (n-type). Among them, |PV_{S1-S6}|<0.3, |PV_{S7}−PV_{S8}|=0, |PV_{S11}−PV_{S12}|=0.57, |PV_{S1}/PV_{S12}|≈0.15, which conform to the above formulas 1-3, and the first surface 101 and the second surface 102, the third surface 201 and the fourth surface 202, the fifth surface 301 and the sixth surface 302, the seventh surface 401 and the eighth surface 402, the ninth surface 501 and the tenth surface 502, and the eleventh surface 601 and the twelfth surface 602 are u-n-type pairs.

### Embodiment 3

PV_{S1}: 0.32 μm (u-type), PV_{S2}: 0.32 μm (n-type), PV_{S3}: 0.32 μm (u-type), PV_{S4}: 0.31 μm (n-type), PV_{S5}: 0.33 μm (n-type), PV_{S6}: 0.32 μm (u type), PV_{S7}: 0.33 μm (n type), PV_{S8}: 0.61 μm (u type), PV_{S9}: 0.93 μm (u type), PV_{S10}: 0.91 μm (n type), PV_{S11}: 1.2 μm (u type) and PV_{S12}: 1.17 μm (n-type). Among them, |PV_{S1-S6}|>0.3, |PV_{S7}−PV_{S8}|=0.28, |PV_{S11}−PV_{S12}|=0.03, |PV_{S1}/PV_{S12}|≈0.27, which do not conform to formulas 1-2, and the first surface 101 and the second surface 102, the third surface 201 and the fourth surface 202, the fifth surface 301 and the sixth surface 302, the seventh surface 401 and the eighth surface 402, the ninth surface 501 and the tenth surface 502, and the eleventh surface 601 and the twelfth surface 602 are not u-n-type or n-u-type pairs.

### Embodiment 4

PV_{S1}: 0.16 μm (u-type), PV_{S2}: 0.16 μm (u-type), PV_{S3}: 0.11 μm (u-type), PV_{S4}: 0.26 μm (u-type), PV_{S5}: 0.25 μm (u-type), PV_{S6}: 0.13 μm (u type), PV_{S7}: 0.23 μm (u type), PV_{S8}: 0.19 μm (u type), PV_{S9}: 0.27 μm (u type), PV_{S10}: 0.15 μm (u type), PV_{S11}: 0.53 μm (u type) and PV_{S12}: 1.17 μm (u-type). Among them, |PV_{S1-S6}|<0.3, |PV_{S7}−PV_{S8}|=0.04, |PV_{S11}−PV_{S12}|=0.64, |PV_{S1}/PV_{S12}|≈0.1368, which conform to formulas 1-3, and the first surface 101 and the second surface 102, the third surface 201 and the fourth surface 202, the fifth surface 301 and the sixth surface 302, the seventh surface 401 and the eighth surface 402, the ninth surface 501 and the tenth surface 502, and the eleventh surface 601 and the twelfth surface 602 are not u-n-type or n-u-type pairs.

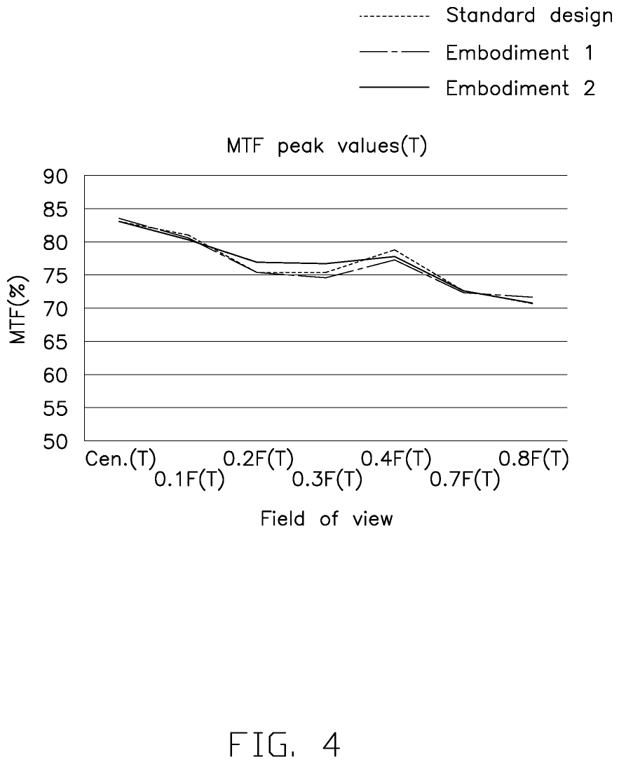

Referring to FIG. 4, it can be seen that MTF peak values of the lens assembly 100 of Embodiment 1 and Embodiment 2 from a center field of view to a peripheral field of view of 0.8 do not differ far from standard design values (the MTF peak differences are less than 5%).

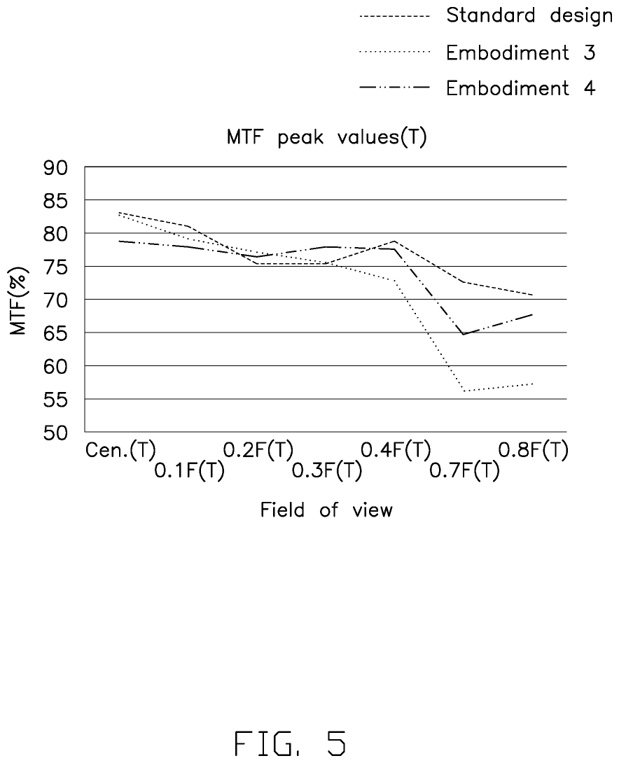

Referring to FIG. 5, it can be seen that MTF peak values of the lens assembly 100 of Embodiment 3 and Embodiment 4 from a center field of view to a peripheral field of view of 0.8 differ far from standard design values (the MTF peak differences are greater than 5%), such as if conditions are exceeded, the MTF peak values will decrease due to PV errors.

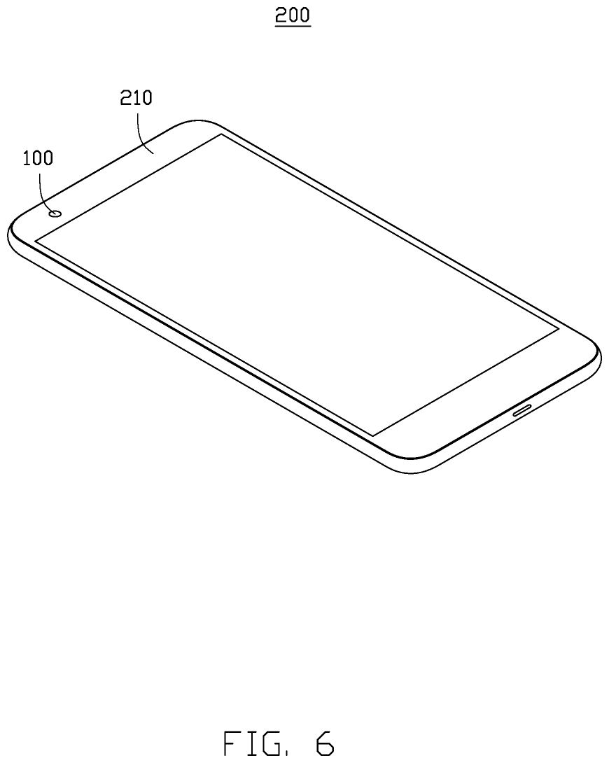

As shown in FIG. 6, the present application further provides an electronic device 200 including the lens assembly 100. The electronic device 200 includes a body 210, and the lens assembly 100 is arranged in the body 210. The electronic device 200 may be a mobile phone, a notebook computer, a desktop computer, a game console, or the like.

In summary, the difference between the actual surface shape and the standard surface shape of each surface of the first lens, the second lens, the third lens, the fourth lens, the fifth lens, and the sixth lens is restricted to effectively improve the imaging effect of the first lens, the second lens, the third lens, the fourth lens, the fifth lens, and the sixth lens. The first surface and the second surface, the third surface and the fourth surface, the fifth surface and the sixth surface, the seventh surface and the eighth surface, the ninth surface and the tenth surface, and the eleventh surface and the twelfth surface are designed to be u-n-type or n-u-type pairs, so that the first lens, the second lens, the third lens, the fourth lens, the fifth lens, and the sixth lens have complementary effects, thereby further improving imaging quality.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A lens assembly comprising:
a first lens comprising a first surface and a second surface;
a second lens comprising a third surface and a fourth surface;
a third lens comprising a fifth surface and a sixth surface;
a fourth lens comprising a seventh surface and an eighth surface;
a fifth lens comprising a ninth surface and a tenth surface; and
a sixth lens comprising an eleventh surface and a twelfth surface; wherein:
the first lens, the second lens, the third lens, the fourth lens, the fifth lens, and the sixth lens are sequentially arranged from an object side to an image side; and
the lens assembly satisfies the following relationships:

|PV_{S1-S6}|≤0.3 (Formula 1);

|PV_{S7}−PV_{S8}|≤|PV_{S11}−PV_{S12}|≤1 (Formula 2);

|PV_{S1}/PV_{S12}|≤3 (Formula 3);
PV is an error between an actual surface shape and a standard surface shape of the first lens, the second lens, the third lens, the fourth lens, the fifth lens, and the sixth lens; and
PV_{Sn} is an error of crests and troughs between an actual surface shape and a standard surface shape of the first surface to an nth surface, and n is a positive integer less than 13.

2. The lens assembly of claim 1, wherein:
the first surface and the second surface, the third surface and the fourth surface, the fifth surface and the sixth surface, the seventh surface and the eighth surface, the ninth surface and the tenth surface, and the eleventh surface and the twelfth surface are u-n-type or n-u-type pairs.

3. The lens assembly of claim 1, wherein:
the lens assembly comprises an optical axis; and
the first lens, the second lens, the third lens, the fourth lens, the fifth lens, and the sixth lens are all arranged symmetrically about the optical axis.

4. The lens assembly of claim 1, wherein:
the lens assembly further comprises a filter located on a side of the sixth lens facing away from the fifth lens.

5. The lens assembly of claim 4, further comprising an image surface, wherein:
the filter is located between the sixth lens and the image surface.

6. The lens assembly of claim 1, wherein:
the first surface protrudes toward the object side, and the second surface is a flat surface;
the third surface is a flat surface facing the second surface, and the fourth surface is recessed toward the object side;
the fifth surface is recessed toward the image side, and the sixth surface protrudes toward the image side;
the seventh surface faces the sixth surface;
two ends of the seventh surface are flat surfaces, and a middle portion of the seventh surface is recessed toward the image side;
the eighth surface protrudes toward the image side;
the ninth surface faces the eighth surface;
two ends of the ninth surface are flat surfaces, and a middle portion of the ninth surface is recessed toward the image side;
the tenth surface protrudes toward the image side;
the eleventh surface faces the tenth surface;
two ends of the eleventh surface are flat surfaces, and a middle portion of the eleventh surface is recessed toward the image side;
two ends of the twelfth surface protrude toward the image side, and a middle portion of the twelfth surface is recessed toward the object side.

7. The lens assembly of claim 6, wherein:
a thickness of a middle portion of the fifth lens is greater than a thickness of the two ends of the fifth lens.

8. The lens assembly of claim 6, wherein:
a thickness of a middle portion of the sixth lens is smaller than a thickness of the two ends of the sixth lens.

9. The lens assembly of claim 1, wherein:
the first lens, the second lens, the third lens, the fourth lens, the fifth lens, and the sixth lens are aspherical lenses that satisfy the following formula:
$$Z = \frac{c {r}^{2}}{1 + \sqrt{1 - ( 1 + K ) {c}^{2} {r}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16} + {A}_{18} {h}^{18} + {A}_{20} {h}^{20} + {A}_{22} {h}^{22}$$
wherein:
z is a concavity of an aspheric surface;
c is a reciprocal of a radius of curvature;
r is an off-axis radius;
k is a conic coefficient; and
A4, A6, A8, A10, A12, A14, A16, A18, A20, A22 are order coefficients of the aspheric surfaces.

10. An electronic device comprising:
a body; and
at least one lens assembly arranged in the body, the at least one lens assembly comprising:
a first lens comprising a first surface and a second surface;
a second lens comprising a third surface and a fourth surface;
a third lens comprising a fifth surface and a sixth surface;
a fourth lens comprising a seventh surface and an eighth surface;
a fifth lens comprising a ninth surface and a tenth surface; and
a sixth lens comprising an eleventh surface and a twelfth surface; wherein:
the first lens, the second lens, the third lens, the fourth lens, the fifth lens, and the sixth lens are sequentially arranged from an object side to an image side; and
the lens assembly satisfies the following relationships:

|PV_{S1-S6}|≤0.3 (Formula 1);

|PV_{S7}−PV_{S8}|≤|PV_{S11}−PV_{S12}|≤1 (Formula 2);

|PV_{S1}/PV_{S12}|≤3 (Formula 3);
PV is an error between an actual surface shape and a standard surface shape of the first lens, the second lens, the third lens, the fourth lens, the fifth lens, and the sixth lens; and
PV_{Sn} is an error of crests and troughs between an actual surface shape and a standard surface shape of the first surface to an nth surface, and n is a positive integer less than 13.

11. The electronic device of claim 10, wherein:
the first surface and the second surface, the third surface and the fourth surface, the fifth surface and the sixth surface, the seventh surface and the eighth surface, the ninth surface and the tenth surface, and the eleventh surface and the twelfth surface are u-n-type or n-u-type pairs.

12. The electronic device of claim 11, wherein:
the lens assembly comprises an optical axis; and
the first lens, the second lens, the third lens, the fourth lens, the fifth lens, and the sixth lens are all arranged symmetrically about the optical axis.

13. The electronic device of claim 12, wherein:
the lens assembly further comprises a filter located on a side of the sixth lens facing away from the fifth lens.

14. The electronic device of claim 13, further comprising an image surface, wherein:
the filter is located between the sixth lens and the image surface.

15. The electronic device of claim 14, wherein:
the first surface protrudes toward the object side, and the second surface is a flat surface;
the third surface is a flat surface facing the second surface, and the fourth surface is recessed toward the object side;
the fifth surface is recessed toward the image side, and the sixth surface protrudes toward the image side;
the seventh surface faces the sixth surface;
two ends of the seventh surface are flat surfaces, and a middle portion of the seventh surface is recessed toward the image side;
the eighth surface protrudes toward the image side;
the ninth surface faces the eighth surface;
two ends of the ninth surface are flat surfaces, and a middle portion of the ninth surface is recessed toward the image side;
the tenth surface protrudes toward the image side;
the eleventh surface faces the tenth surface;
two ends of the eleventh surface are flat surfaces, and a middle portion of the eleventh surface is recessed toward the image side;
two ends of the twelfth surface protrude toward the image side, and a middle portion of the twelfth surface is recessed toward the object side.

16. The electronic device of claim 15, wherein:
a thickness of a middle portion of the fifth lens is greater than a thickness of the two ends of the fifth lens.

17. The electronic device of claim 16, wherein:
a thickness of a middle portion of the sixth lens is smaller than a thickness of the two ends of the sixth lens.

18. The electronic device of claim 17, wherein:
the first lens, the second lens, the third lens, the fourth lens, the fifth lens, and the sixth lens are aspherical lenses that satisfy the following formula:
$$Z = \frac{c {r}^{2}}{1 + \sqrt{1 - ( 1 + K ) {c}^{2} {r}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16} + {A}_{18} {h}^{18} + {A}_{20} {h}^{20} + {A}_{22} {h}^{22}$$
wherein:
z is a concavity of an aspheric surface;
c is a reciprocal of a radius of curvature;
r is an off-axis radius;
k is a conic coefficient; and
A4, A6, A8, A10, A12, A14, A16, A18, A20, A22 are order coefficients of the aspheric surfaces.
